(19) United States
(12) Patent Application Publication
(10) Pub. No.: US 2024/0017686 A1
(43) Pub. Date: Jan. 18, 2024

(54) WIRE HARNESS AND MANUFACTURING METHOD

(71) Applicant: YAZAKI CORPORATION, Tokyo (JP)

(72) Inventors: Ryo Nagashima, Makinohara-shi (JP); Harutake Satoh, Makinohara-shi (JP)

(21) Appl. No.: 18/336,956

(22) Filed: Jun. 16, 2023

(30) Foreign Application Priority Data
Jul. 13, 2022 (JP) 2022-112722

(51) Int. Cl. B60R 16/02; H02G 3/04

(52) U.S. Cl. CPC B60R 16/0215; H02G 3/04

(57) ABSTRACT

A wire harness includes a protective member configured to protect an electric wire routed in a vehicle. The protective member is constituted by a protector and a tape. A surrounding of the electric wire is covered with at least one of the protector and the tape of the protective member. A portion where the electric wire is covered with the protector is a place where interference with the electric wire from an external interference member installed in the vehicle is large compared with a portion where the electric wire is covered with the tape. The tape has a protection function equivalent to that in a case where the electric wire is covered with a tube.

### CROSS-REFERENCE TO RELATED APPLICATIONS

This application is based on and claims priority under 35 USC 119 from Japanese Patent Application No. 2022-112722 filed on Jul. 13, 2022, the contents of which are incorporated herein by reference.

### TECHNICAL FIELD

The present disclosure relates to a wire harness to be mounted on an autonomous vehicle or the like, and more particularly, to a wire harness including a protective member that protects an electric wire against interference with an external interference member.

### BACKGROUND ART

Patent Literature 1 discloses a wire harness to be routed in a vehicle. The wire harness covers an electric wire with a tape, and fixes a protector serving as a protective member to a necessary portion by tape winding, thereby protecting the electric wire against an external interference member such as another component or a vehicle body.

### CITATION LIST

### Patent Literature

Patent Literature 1: JP2007-143212A

### SUMMARY OF INVENTION

In the above-described wire harness, the protector is uniformly provided to protect even portions around which the tape is wound from the external interference member, and thus the cost increases.

The present disclosure is made in view of the above circumstance and an object of the present disclosure is to provide a wire harness that can appropriately protect an electric wire with a protective member against an external interference member.

The above object of the present disclosure is implemented by the following configuration.

A wire harness of the present disclosure includes a protective member configured to protect an electric wire routed in a vehicle. The protective member is constituted by a protector and a tape, a surrounding of the electric wire is covered with at least one of the protector and the tape of the protective member, a portion where the electric wire is covered with the protector is a place where interference with the electric wire from an external interference member installed in the vehicle is large compared with a portion where the electric wire is covered with the tape, and the tape has a protection function equivalent to that in a case where the electric wire is covered with a tube, by being wound around the electric wire to overlap at least half of the tape in a width direction thereof.

According to the present disclosure, it is possible to provide a wire harness that can appropriately protect an electric wire with a protective member against an external interference member.

The present disclosure is briefly described above. Details of the present disclosure will be further clarified by reading through modes described below for carrying out the present disclosure (hereinafter referred to as “embodiments”) with reference to the accompanying drawings.

### BRIEF DESCRIPTION OF DRAWINGS

FIG. 1 is a schematic plan view of a wire harness according to a first embodiment of the present disclosure;

FIG. 2 is a schematic side view of the wire harness according to the first embodiment of the present disclosure;

FIG. 3 is a schematic cross-sectional view of the wire harness according to the first embodiment of the present disclosure in a direction perpendicular to an extending direction of electric wires of the wire harness;

FIG. 4 is a perspective view of a protector used in the wire harness according to the first embodiment of the present disclosure;

FIG. 5 is a schematic side view of the wire harness according to the first embodiment in which electric wires for an additional circuit are arranged side by side;

FIG. 6 is a schematic cross-sectional view of the wire harness according to the first embodiment in the direction perpendicular to the extending direction of the electric wires of the wire harness, in which the electric wires for the additional circuit are arranged side by side;

FIG. 7 is a schematic plan view of a wire harness according to a second embodiment of the present disclosure;

FIG. 8 is a schematic side view of the wire harness according to the second embodiment of the present disclosure;

FIG. 9 is a schematic cross-sectional view of the wire harness according to the second embodiment of the present disclosure in a direction perpendicular to an extending direction of electric wires of the wire harness;

FIG. 10 is a perspective view of a protector used in the wire harness according to the second embodiment of the present disclosure;

FIG. 11 is a schematic plan view of a wire harness according to a third embodiment of the present disclosure;

FIG. 12 is a schematic side view of the wire harness according to the third embodiment of the present disclosure;

FIG. 13 is a schematic cross-sectional view of the wire harness according to the third embodiment of the present disclosure in a direction perpendicular to an extending direction of electric wires of the wire harness;

FIG. 14 is a perspective view of a protector used in the wire harness according to the third embodiment of the present disclosure;

FIG. 15 is a schematic plan view of a wire harness according to a fourth embodiment of the present disclosure;

FIG. 16 is a schematic side view of the wire harness according to the fourth embodiment of the present disclosure;

FIG. 17 is a schematic cross-sectional view of the wire harness according to the fourth embodiment of the present disclosure in a direction perpendicular to an extending direction of electric wires of the wire harness;

FIG. 18 is a perspective view of a protector used in the wire harness according to the fourth embodiment of the present disclosure;

FIG. 19 is a schematic plan view of a wire harness according to a fifth embodiment of the present disclosure;

FIG. 20 is a schematic side view of the wire harness according to the fifth embodiment of the present disclosure;

FIG. 21 is a schematic cross-sectional view of the wire harness according to the fifth embodiment of the present disclosure in a direction perpendicular to an extending direction of electric wires of the wire harness;

FIG. 22 is a perspective view of a protector used in the wire harness according to the fifth embodiment of the present disclosure;

FIG. 23 is a schematic plan view of a wire harness according to a sixth embodiment of the present disclosure;

FIG. 24 is a schematic side view of the wire harness according to the sixth embodiment of the present disclosure;

FIG. 25 is a schematic cross-sectional view of the wire harness according to the sixth embodiment of the present disclosure in a direction perpendicular to an extending direction of electric wires of the wire harness;

FIG. 26 is a perspective view of a protector used in the wire harness according to the sixth embodiment of the present disclosure;

FIG. 27 is a perspective view of another protector used in the wire harness according to the sixth embodiment of the present disclosure;

FIG. 28 is a schematic plan view of a wire harness according to a seventh embodiment of the present disclosure;

FIG. 29 is a schematic side view of the wire harness according to the seventh embodiment of the present disclosure;

FIG. 30 is a schematic cross-sectional view of the wire harness according to the seventh embodiment of the present disclosure in a direction perpendicular to an extending direction of electric wires of the wire harness;

FIG. 31 is a perspective view of a protector used in the wire harness according to the seventh embodiment of the present disclosure; and

FIG. 32 is a perspective view of another protector used in the wire harness according to the seventh embodiment of the present disclosure.

### DESCRIPTION OF EMBODIMENTS

Specific embodiments of the present disclosure will be described below with reference to the drawings.

### First Embodiment

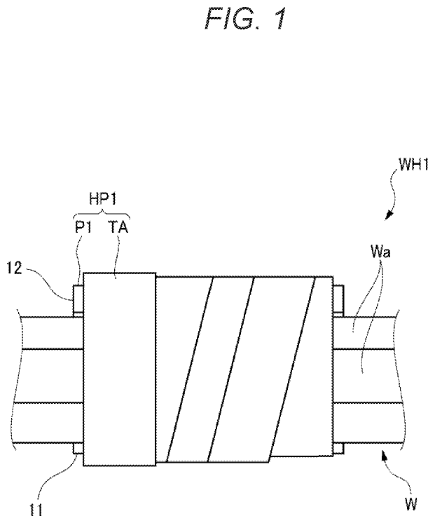

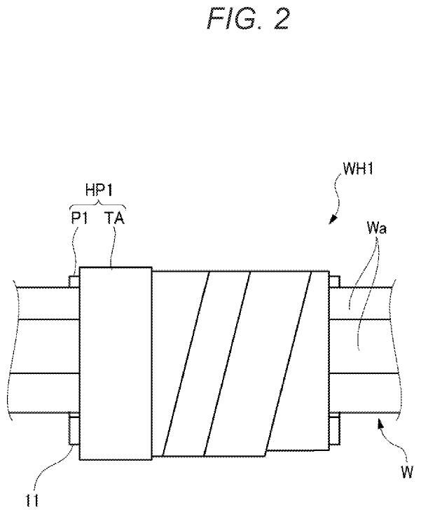

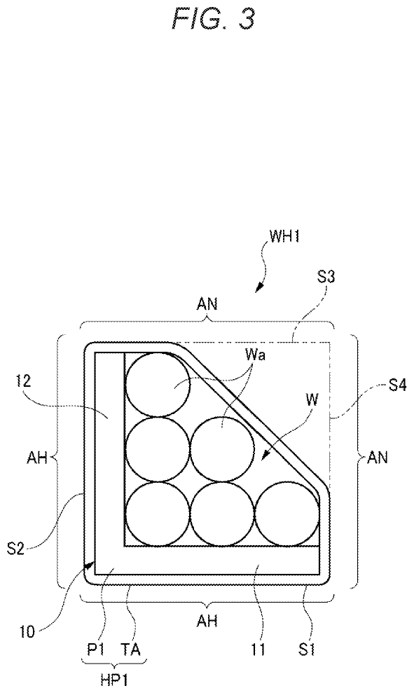

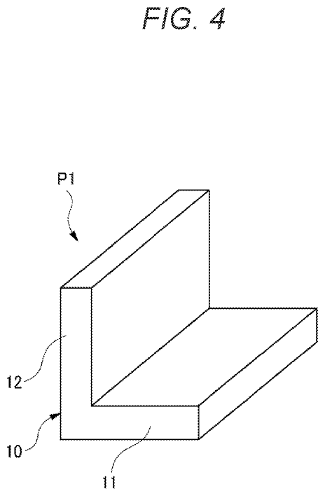

FIG. 1 is a schematic plan view of a wire harness according to a first embodiment of the present disclosure. FIG. 2 is a schematic side view of the wire harness according to the first embodiment of the present disclosure. FIG. 3 is a schematic cross-sectional view of the wire harness according to the first embodiment of the present disclosure in a direction perpendicular to an extending direction of electric wires of the wire harness. FIG. 4 is a perspective view of a protector used in the wire harness according to the first embodiment of the present disclosure.

As shown in FIGS. 1 to 3, a wire harness WH1 according to the first embodiment includes a protective member HP1 in a predetermined section (a part that may interfere with an external interference member) of electric wires Wa. The electric wires Wa are routed in a vehicle, and a plurality of electric wires Wa are bundled to form an electric wire bundle W. The protective member HP1 is constituted by a protector P1 and a tape TA, and the electric wires Wa are covered around with the protective member HP1.

As shown in FIGS. 3 and 4, the protector P1 constituting the protective member HP1 has an L-shaped part 10 constituting two sides of a rectangle in a vertical cross section relative to the extending direction of the electric wires Wa. The L-shaped part 10 is integrally formed such that two flat plate portions 11 and 12 are orthogonal to each other. The protector P1 is formed of a synthetic resin or the like. The electric wires Wa are arranged at a corner portion of the L-shaped part 10 constituted by the flat plate portions 11 and 12 of the protector P1. Accordingly, when the electric wire bundle W including the electric wires Wa is surrounded by four sides S1 to S4 of an imaginary rectangle in the vertical cross section relative to the extending direction of the electric wires Wa, the two sides S1 and S2 adjacent to each other of the imaginary rectangle are covered with the protector P1 and protected against interference with the external interference member.

The tape TA is wound around the protector P1 and a predetermined section where the protector P1 is provided of the electric wire bundle W including the electric wires Wa. Accordingly, the electric wires Wa and the protector P1 are covered with the tape TA on the outer periphery. Accordingly, the two sides S3 and S4 other than the two sides S1 and S2 covered with the protector P1 are covered with the tape TA, and the electric wires Wa are protected against interference with the external interference member.

The tape TA is a polyvinyl chloride tape (PVC tape) having a thickness of 0.24 mm or less and a stretch rate of 200% or more in a longitudinal direction. The tape TA more preferably has a stretch rate of 300% or more.

In the present embodiment, the tape TA is wound in a state in which substantially half of the tape TA, which is a part thereof in a width direction, is wrapped and this state is referred to as half wrapping. An adhesive material is applied (including stuck) to an entire back surface of the tape TA in advance. The adhesive material fixes the electric wires Wa to the tape TA, the protector P1 to the tape TA, and the tape TA to itself (tapes in the wrapped part). By wrapping the tape TA, a part around which the tape TA is wound becomes double winding having a large thickness (0.48 mm), implements a protection function equivalent to that in a case where the part is covered with a tube having a thickness of substantially 0.5 mm, and has a wear resistance close to that of the protector P1. That is, the tape TA wound in the half wrapping has such a strength that the tape TA can be used as a substitute for a resin protector.

Since the tape TA has a thickness of 0.24 mm or less and a stretch rate of 200% or more in the longitudinal direction, the tape TA can be wound around the electric wires Wa and the protector P1 while maintaining a reliable tight contact state.

In this manner, in the wire harness WH1 including the protective member HP1 constituted by the protector P1 and the tape TA, the two sides S3 and S4 covered with only the tape TA are normally protected areas AN, and the two sides S1 and S2 covered with the protector P1 are highly protected areas AH protected at a higher protection strength than the normally protected areas AN. The highly protected area AH is, for example, an area where a distance therefrom to the external interference member is shorter than that from the normally protected area AN, or where an external interference member harder than an external interference member disposed in the normally protected area AN is disposed.

The wire harness WH1 is routed such that, compared to a portion covered with the tape TA, a place where interference with the electric wires Wa from an external interference member installed in the vehicle is large is disposed in the highly protected area AH covered with the protector P1.

In this manner, according to the wire harness WH1 according to the first embodiment, since the tape TA has a thickness of 0.24 mm or less and a stretch rate of 200% or more in the longitudinal direction, the tape TA can be wound to be in tight contact with the electric wires Wa and the protector P1 while preventing peeling due to floating. In addition, as compared with the portion covered with the tape TA, the place of the electric wires Wa where the interference with the external interference member is large is covered with the protector P1. Accordingly, as compared with a structure in which electric wires are uniformly covered with and protected by a protector, the electric wires Wa can be appropriately protected against the external interference member while reducing the cost.

When attention is paid to only the protection function for the wire harness WH1, tape winding with a fabric tape having a large thickness is also considered. However, such a fabric tape cannot be cut off by a worker by hand, and it is necessary to prepare a tape cut off at a predetermined length in advance or to cut off the tape with a cutter or the like every time the worker winds the tape, resulting in a remarkable decrease in efficiency. In contrast, since the tape TA according to the present embodiment can be cut off by the worker by hand, the tape TA can be used as a protective member for the wire harness WH1 while maintaining work efficiency.

Next, a case where electric wires for an additional circuit are arranged side by side in the wire harness WH1 will be described.

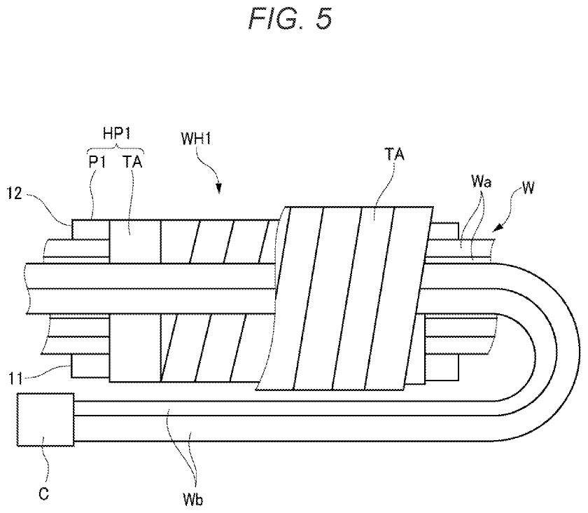

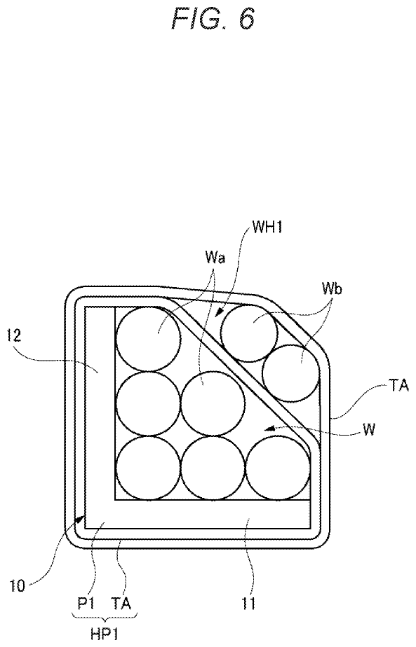

FIG. 5 is a schematic side view of the wire harness according to the first embodiment in which the electric wires for the additional circuit are arranged side by side. FIG. 6 is a schematic cross-sectional view of the wire harness according to the first embodiment in the direction perpendicular to the extending direction of the electric wires of the wire harness, in which the electric wires for the additional circuit are arranged side by side.

As shown in FIGS. 5 and 6, in the wire harness WH1, a plurality of electric wires Wb for an additional circuit including a connector C at an end portion thereof may be arranged side by side. In such a case, the electric wires Wb are arranged along the normally protected area AN in which the electric wires Wa are covered with the tape TA in the predetermined section covered with the protective member HP1 of the wire harness WH1. Then, the electric wires Wb and the protective member HP1 are bundled to the wire harness WH1 by winding the tape TA having a thickness of 0.24 mm or less and a stretch rate of 200% or more in the longitudinal direction around the electric wires Wb and the protective member HP1. In this manner, when the tape TA is used, the electric wires Wb for the additional circuit can be easily wound around the protective member HP1 and arranged side by side with the wire harness WH1.

Next, wire harnesses according to second to seventh embodiments will be described.

The same components as those of the first embodiment are denoted by the same reference numerals, and description thereof is omitted.

### Second Embodiment

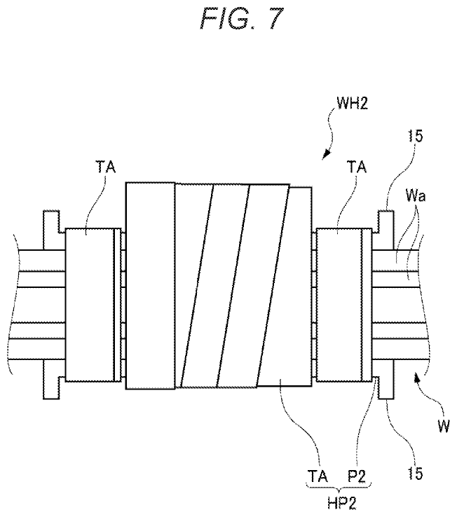

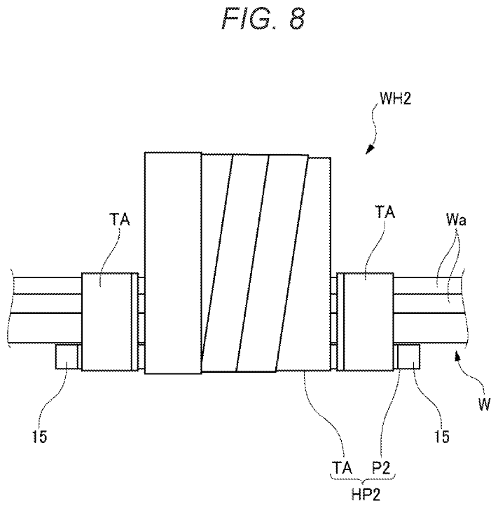

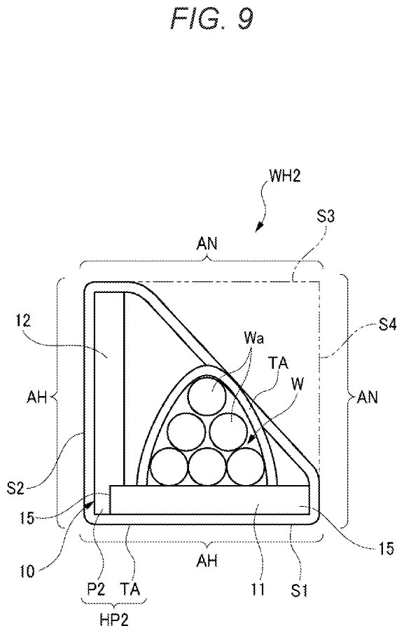

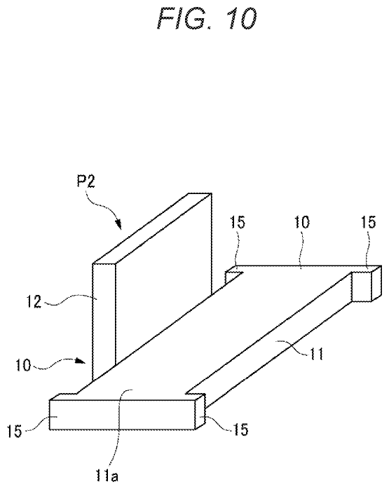

FIG. 7 is a schematic plan view of the wire harness according to the second embodiment of the present disclosure. FIG. 8 is a schematic side view of the wire harness according to the second embodiment of the present disclosure. FIG. 9 is a schematic cross-sectional view of the wire harness according to the second embodiment of the present disclosure in a direction perpendicular to an extending direction of electric wires of the wire harness. FIG. 10 is a perspective view of a protector used in the wire harness according to the second embodiment of the present disclosure.

As shown in FIGS. 7 to 9, a wire harness WH2 according to the second embodiment includes a protective member HP2 in a predetermined section (a part that may interfere with an external interference member) of the electric wires Wa. The protective member HP2 is constituted by a protector P2 and the tape TA, and the electric wires Wa are covered around with the protective member HP2.

As shown in FIGS. 9 and 10, the protector P2 constituting the protective member HP2 also has the L-shaped part 10 constituting two sides of a rectangle in a vertical cross section relative to the extending direction of the electric wires Wa. The L-shaped part 10 is integrally formed such that two flat plate portions 11 and 12 are orthogonal to each other. In the protector P2, the flat plate portion 11 includes a pair of extending portions 11a extending in corresponding two directions in the extending direction of the electric wires Wa further than the flat plate portion 12, and includes, at each of end portions of the pair of extending portions 11a, a flange portion 15 protruding toward a respective lateral side.

Also in the case of the wire harness WH2, the tape TA is wound around the protector P2 and a predetermined section where the protector P2 is provided of the electric wire bundle W including the electric wires Wa. Accordingly, the electric wires Wa and the protector P2 are covered with the tape TA on the outer periphery. In the wire harness WH2, the tape TA is wound around the electric wires Wa and the extending portions 11a of the flat plate portion 11 of the protector P2.

In this manner, also in the case of the wire harness WH2 including the protective member HP2 constituted by the protector P2 and the tape TA, the two sides S3 and S4 covered with only the tape TA are the normally protected areas AN, and the two sides S1 and S2 covered with the protector P2 are the highly protected areas AH protected with a higher protection strength than the normally protected areas AN.

In particular, in the wire harness WH2, since the tape TA is wound around the electric wires Wa and the extending portions 11a of the flat plate portion 11 of the protector P2, the electric wires Wa can be firmly bundled to the protector P2. Since the flange portion 15 is provided at each of the end portions of the extending portions 11a of the flat plate portion 11 around which the tape TA is wound, due to the flange portion 15, the tape TA is prevented from being pulled out when being wound around the electric wires Wa and the extending portions 11a of the flat plate portion 11. Accordingly, the tape TA can be reliably wound.

### Third Embodiment

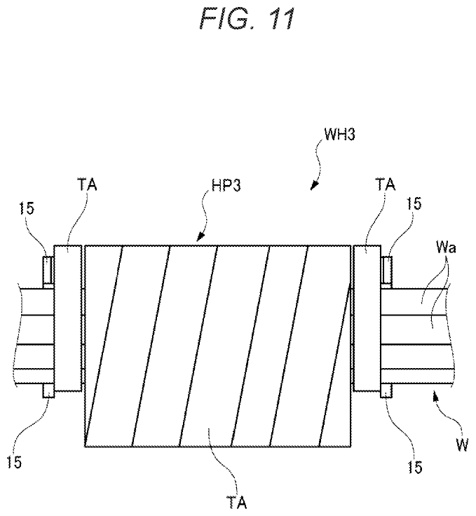

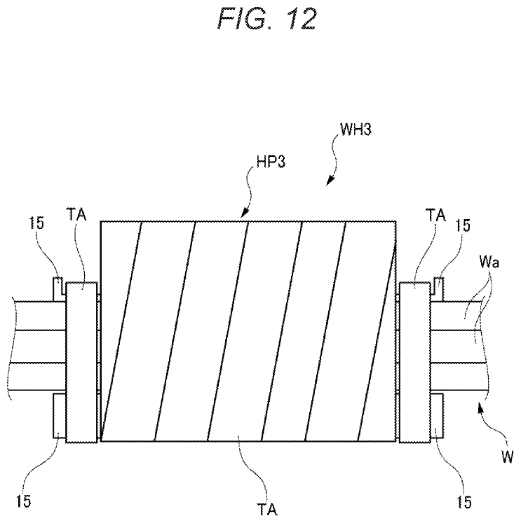

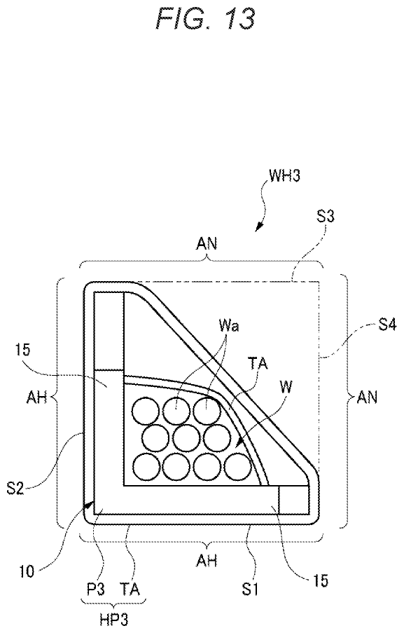

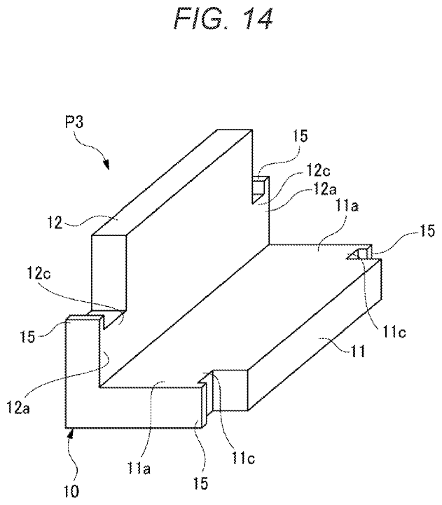

FIG. 11 is a schematic plan view of the wire harness according to the third embodiment of the present disclosure. FIG. 12 is a schematic side view of the wire harness according to the third embodiment of the present disclosure. FIG. 13 is a schematic cross-sectional view of the wire harness according to the third embodiment of the present disclosure in a direction perpendicular to an extending direction of electric wires of the wire harness. FIG. 14 is a perspective view of a protector used in the wire harness according to the third embodiment of the present disclosure.

As shown in FIGS. 11 to 13, a wire harness WH3 according to the third embodiment includes a protective member HP3 in a predetermined section (a part that may interfere with an external interference member) of the electric wires Wa. The protective member HP3 is constituted by a protector P3 and the tape TA, and the electric wires Wa are covered around with the protective member HP3.

As shown in FIGS. 13 and 14, the protector P3 constituting the protective member HP3 also has the L-shaped part 10 constituting two sides of a rectangle in a vertical cross section relative to the extending direction of the electric wires Wa. The L-shaped part 10 is integrally formed such that two flat plate portions 11 and 12 are orthogonal to each other. In the protector P3, the flat plate portions 11 and 12 respectively include extending portions 11a and 12a extending in the extending direction of the electric wires Wa, and the flange portion 15 protruding toward a respective lateral side is formed on each of end portions of the extending portions 11a and 12a. The extending portions 11a and 12a respectively include small-width portions 11c and 12c having a smaller width than body parts and the flange portions 15 of the flat plate portions 11 and 12. The small-width portions 11c and 12c are provided in the same position in the extending direction of the electric wires Wa.

Also in the case of the wire harness WH3, the tape TA is wound around the protector P3 and a predetermined section where the protector P3 is provided of the electric wire bundle W including the electric wires Wa. Accordingly, the electric wires Wa and the protector P3 are covered with the tape TA on the outer periphery. In the wire harness WH3, the tape TA is wound around the electric wires Wa and the extending portions 11a and 12a of the flat plate portions 11 and 12 of the protector P3.

In this manner, also in the case of the wire harness WH3 including the protective member HP3 constituted by the protector P3 and the tape TA, the two sides S3 and S4 covered with only the tape TA are the normally protected areas AN, and the two sides S1 and S2 covered with the protector P3 are the highly protected areas AH protected with a higher protection strength than the normally protected areas AN.

In the wire harness WH3, similar to the wire harness WH2, since the tape TA is wound around the electric wires Wa and the extending portions 11a and 12a of the flat plate portions 11 and 12 of the protector P3, the electric wires Wa can be firmly bundled to the protector P3. Since the flange portion 15 is provided at each of the end portions of the extending portions 11a and 12a of the flat plate portions 11 and 12 around which the tape TA is wound, due to the flange portion 15, the tape TA is prevented from being pulled out when being wound around the electric wires Wa and the extending portions 11a and 12a of the flat plate portions 11 and 12. Accordingly, the tape TA can be reliably wound.

### Fourth Embodiment

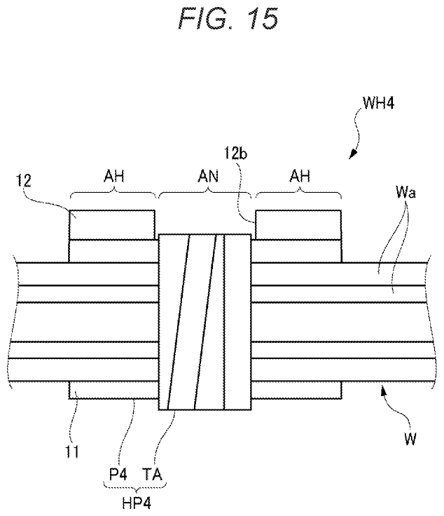

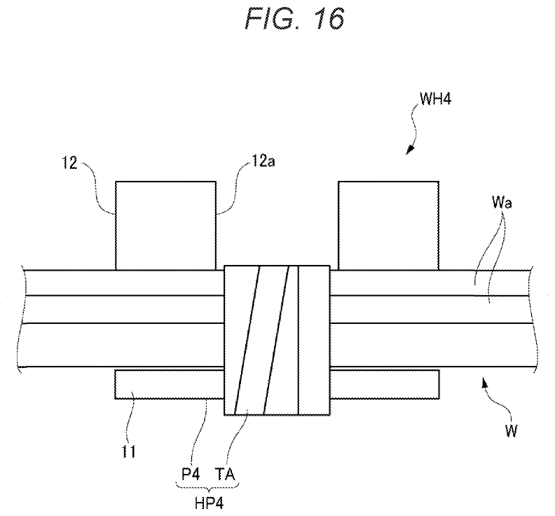

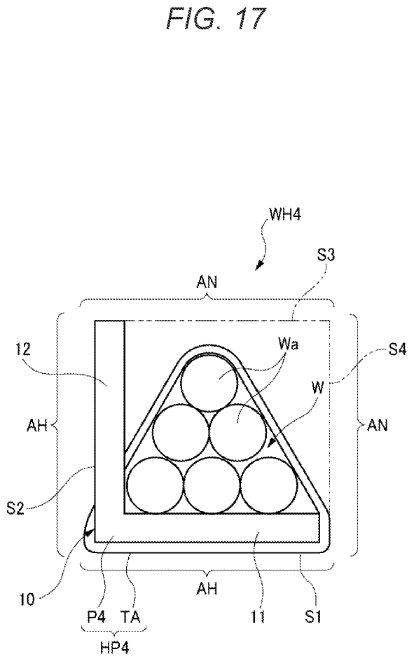

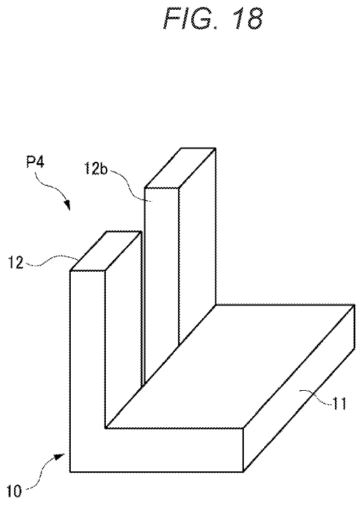

FIG. 15 is a schematic plan view of the wire harness according to the fourth embodiment of the present disclosure. FIG. 16 is a schematic side view of the wire harness according to the fourth embodiment of the present disclosure. FIG. 17 is a schematic cross-sectional view of the wire harness according to the fourth embodiment of the present disclosure in a direction perpendicular to an extending direction of electric wires of the wire harness. FIG. 18 is a perspective view of a protector used in the wire harness according to the fourth embodiment of the present disclosure.

As shown in FIGS. 15 to 17, a wire harness WH4 according to the fourth embodiment includes a protective member HP4 in a predetermined section (a part that may interfere with an external interference member) of the electric wires Wa. The protective member HP4 is constituted by a protector P4 and the tape TA, and the electric wires Wa are covered around with the protective member HP4.

As shown in FIGS. 17 and 18, the protector P4 constituting the protective member HP4 also has the L-shaped part 10 constituting two sides of a rectangle in a vertical cross section relative to the extending direction of the electric wires Wa. The protector P4 includes a notch portion 12b in the flat plate portion 12 constituting the L-shaped part 10. Accordingly, the flat plate portion 12 is divided in a routing direction of the electric wires Wa.

Also in the case of the wire harness WH4, the tape TA is wound around the protector P4 and a predetermined section where the protector P4 is provided of the electric wire bundle W including the electric wires Wa. The tape TA is wound around the notch portion 12b of the flat plate portion 12, so that the electric wires Wa and the flat plate portion 11 of the protector P4 are covered with and bundled by the tape TA on the outer periphery.

In this manner, also in the case of the wire harness WH4 including the protective member HP4 constituted by the protector P4 and the tape TA, the two sides S3 and S4 covered with only the tape TA are the normally protected areas AN, and the two sides S1 and S2 covered with the protector P4 are the highly protected areas AH protected with a higher protection strength than the normally protected areas AN. In the highly protected area AH covered with the flat plate portion 12 of the protector P4, a portion covered with only the tape TA in the notch portion 12b is the normally protected area AN (see FIG. 15).

### Fifth Embodiment

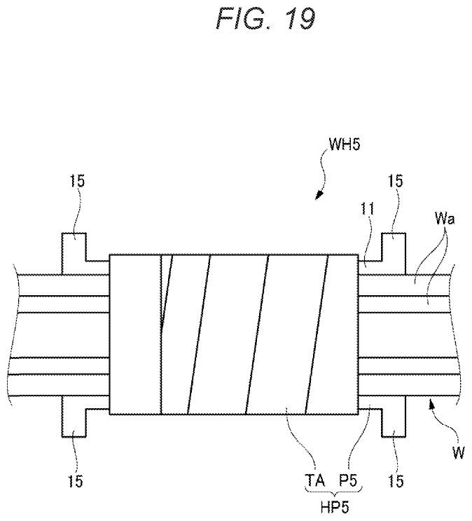

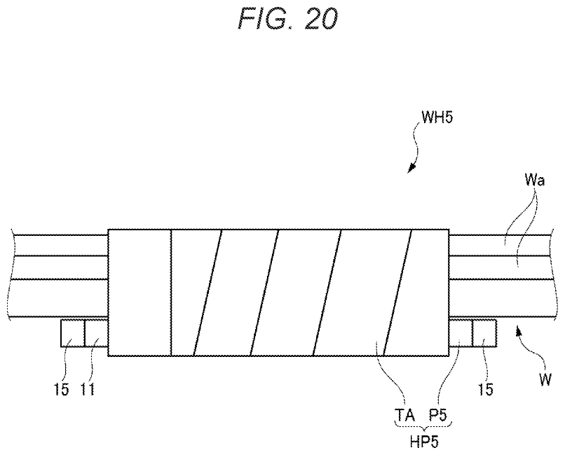

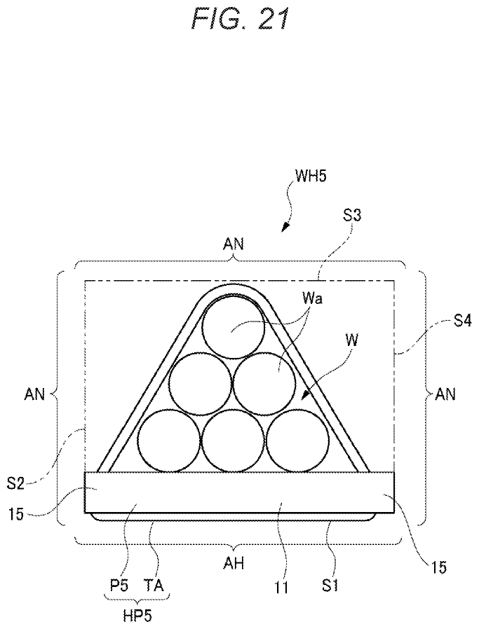

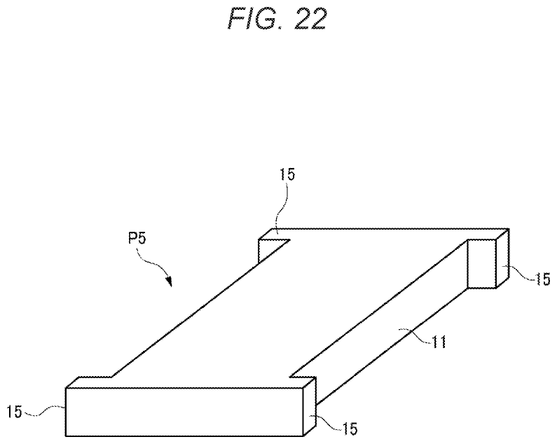

FIG. 19 is a schematic plan view of the wire harness according to the fifth embodiment of the present disclosure. FIG. 20 is a schematic side view of the wire harness according to the fifth embodiment of the present disclosure. FIG. 21 is a schematic cross-sectional view of the wire harness according to the fifth embodiment of the present disclosure in a direction perpendicular to an extending direction of electric wires of the wire harness. FIG. 22 is a perspective view of a protector used in the wire harness according to the fifth embodiment of the present disclosure.

As shown in FIGS. 19 to 21, a wire harness WH5 according to the fifth embodiment includes a protective member HP5 in a predetermined section (a part that may interfere with an external interference member) of the electric wires Wa. The protective member HP5 is constituted by a protector P5 and the tape TA, and the electric wires Wa are covered around with the protective member HP5.

As shown in FIGS. 21 and 22, the protector P5 constituting the protective member HP5 is constituted by one flat plate portion 11. The flat plate portion 11 includes the flange portion 15 protruding toward a respective lateral side at each of end portions thereof.

In the wire harness WH5, the tape TA is wound around the protector P5 and a predetermined section where the protector P5 is provided of the electric wire bundle W including the electric wires Wa. Accordingly, the electric wires Wa, together with the flat plate portion 11 of the protector P5, are covered with the tape TA on the outer periphery and bundled to the protector P5.

In this manner, also in the case of the wire harness WH5 including the protective member HP5 constituted by the protector P5 and the tape TA, the three sides S2, S3 and S4 covered with only the tape TA are the normally protected areas AN, and the side S1 covered with the protector P5 is the highly protected area AH protected with a higher protection strength than the normally protected areas AN.

### Sixth Embodiment

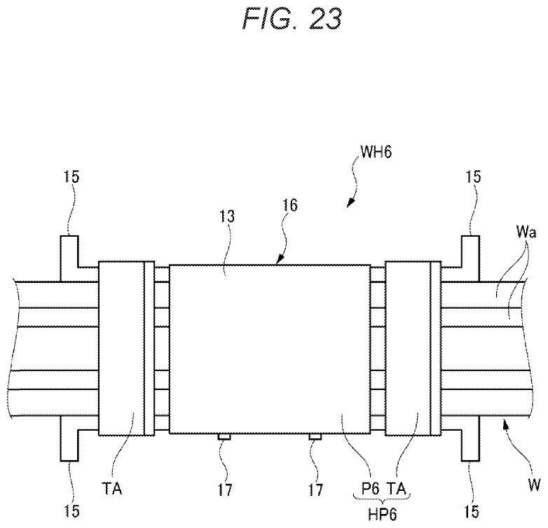

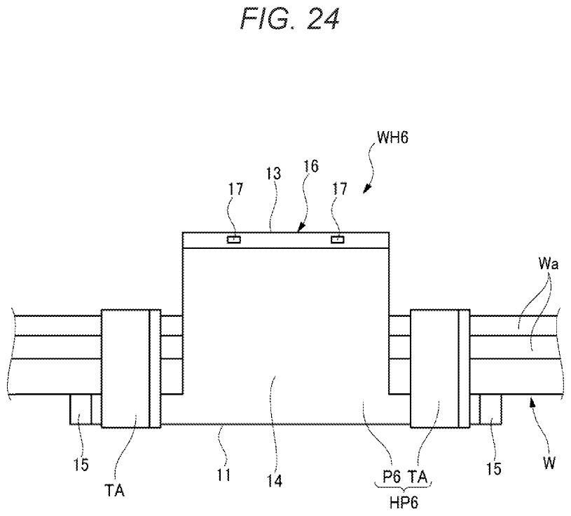

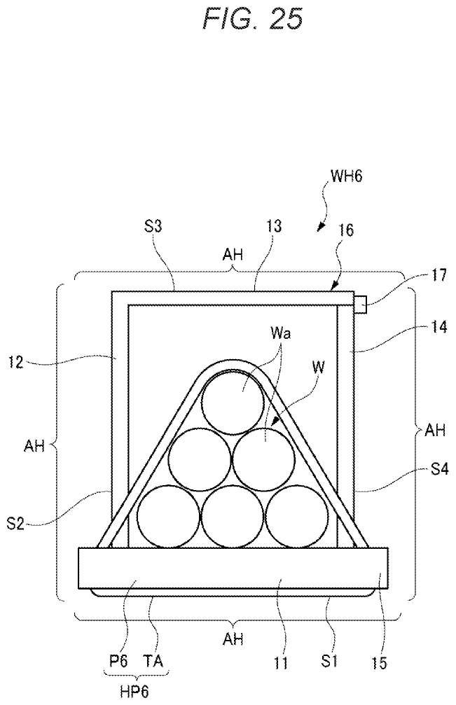

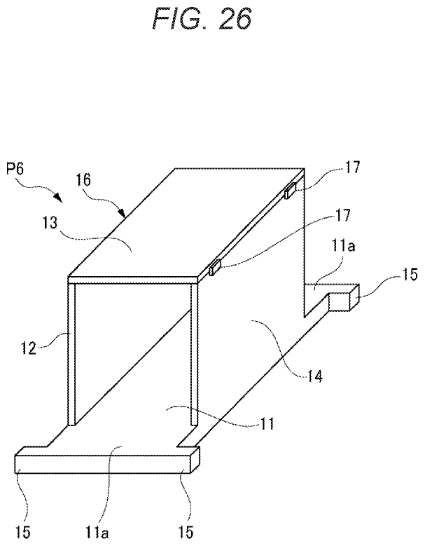

FIG. 23 is a schematic plan view of the wire harness according to the sixth embodiment of the present disclosure. FIG. 24 is a schematic side view of the wire harness according to the sixth embodiment of the present disclosure. FIG. 25 is a schematic cross-sectional view of the wire harness according to the sixth embodiment of the present disclosure in a direction perpendicular to an extending direction of electric wires of the wire harness. FIG. 26 is a perspective view of a protector used in the wire harness according to the sixth embodiment of the present disclosure.

As shown in FIGS. 23 to 25, a wire harness WH6 according to the sixth embodiment includes a protective member HP6 in a predetermined section (a part that may interfere with an external interference member) of the electric wires Wa. The protective member HP6 is constituted by a protector P6 and the tape TA, and the electric wires Wa are covered around with the protective member HP6.

As shown in FIGS. 25 and 26, the protector P6 constituting the protective member HP6 has a rectangular part 16 constituted by flat plate portions 11 to 14. The flat plate portions 12 and 14 are erected from both lateral edges of the flat plate portion 11. The flat plate portion 13 is provided over upper edge portions of the flat plate portions 12 and 14. Accordingly, the protector P6 is formed in a rectangular shape by the flat plate portions 11 to 14 in a vertical cross section relative to the extending direction of the electric wires Wa. One lateral edge of the flat plate portion 13 is pivotably coupled to the flat plate portion 12. At each of an edge portion that is the other lateral edge of the flat plate portion 13 and an edge portion of the flat plate portion 14 on the flat plate portion 13 side, is provided with a lock portion 17, so that the edge portions of the flat plate portions 13 and 14 are locked by the lock portions 17. The flat plate portion 11 includes the extending portions 11a extending in the extending direction of the electric wires Wa, and the flange portion 15 protruding toward a respective lateral side is formed on each of end portions of the extending portions 11a.

In the wire harness WH6, the electric wires Wa pass through the rectangular part 16 constituted by the flat plate portions 11 to 14 of the protector P6, and the tape TA is wound around the electric wires Wa and the extending portions 11a of the flat plate portion 11 of the protector P6. In the protector P6, the electric wires Wa can be easily disposed inside the rectangular part 16 in a state where an upper portion of the rectangular part 16 is opened by unlocking the lock portions 17 and pivoting the flat plate portion 13 in a direction away from the flat plate portion 14. After the electric wires Wa are disposed inside, the flat plate portion 13 is pivoted toward the flat plate portion 14 and locked by the lock portions 17, whereby the electric wires Wa can pass through the rectangular part 16.

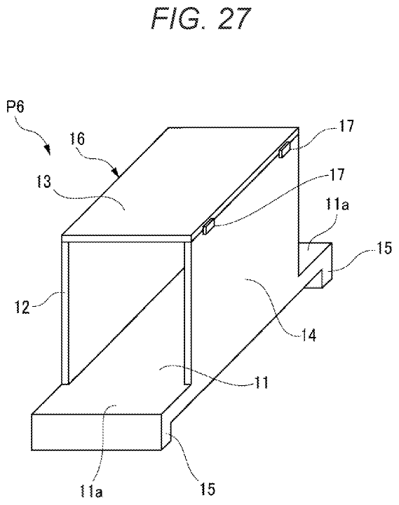

Since the flange portion 15 is provided at each of the end portions of the extending portions 11a of the flat plate portion 11 around which the tape TA is wound, due to the flange portion 15, the tape TA is prevented from being pulled out when being wound around the electric wires Wa and the extending portions 11a of the flat plate portion 11. Accordingly, the tape TA can be reliably wound. As shown in FIG. 27, the flange portion 15 provided on each of the end portions of the flat plate portion 11 of the protector P6 may protrude toward a side of the flat plate portion 11 which is opposite to the side on which the electric wires Wa are disposed.

In this manner, in the wire harness WH6 including the protective member HP6 constituted by the protector P6 and the tape TA, the entire periphery covered with the protector P6 can be the highly protected area AH protected at a higher protection strength than the normally protected area AN.

### Seventh Embodiment

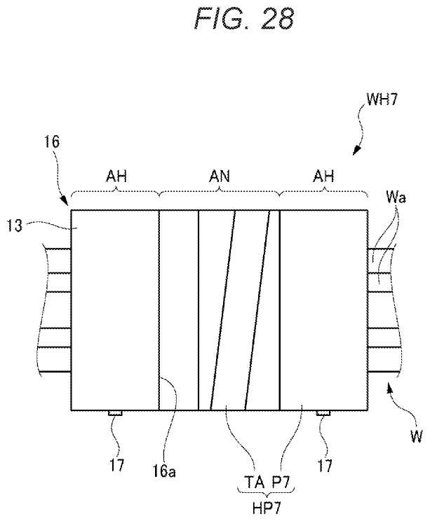

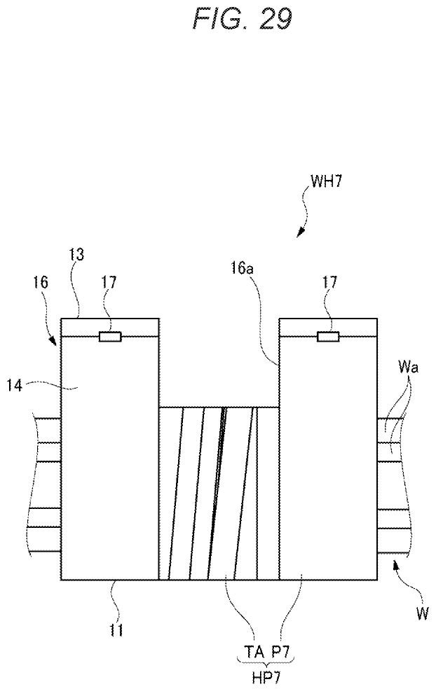

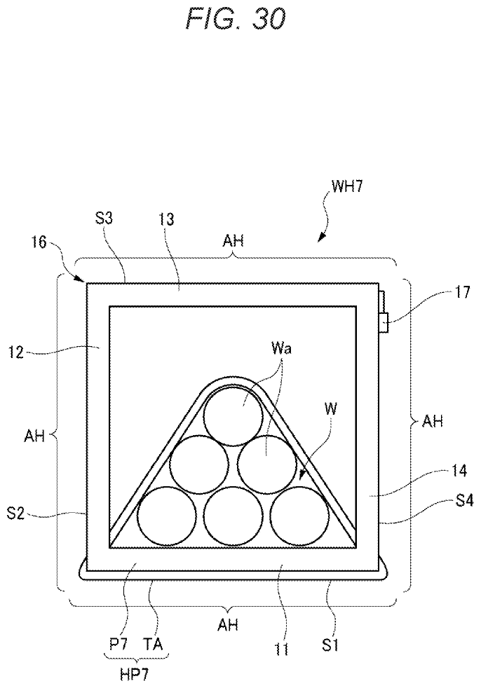

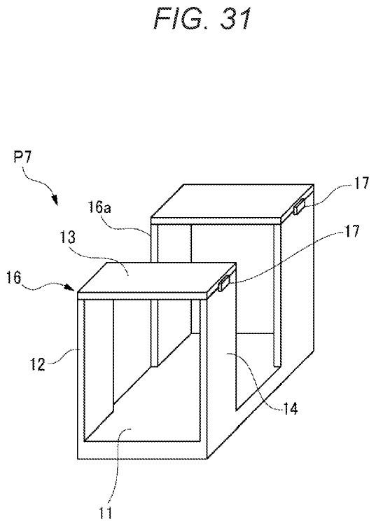

FIG. 28 is a schematic plan view of the wire harness according to the seventh embodiment of the present disclosure. FIG. 29 is a schematic side view of the wire harness according to the seventh embodiment of the present disclosure. FIG. 30 is a schematic cross-sectional view of the wire harness according to the seventh embodiment of the present disclosure in a direction perpendicular to an extending direction of electric wires of the wire harness. FIG. 31 is a perspective view of a protector used in the wire harness according to the seventh embodiment of the present disclosure.

As shown in FIGS. 28 to 30, a wire harness WH7 according to the seventh embodiment includes a protective member HP7 in a predetermined section (a part that may interfere with an external interference member) of the electric wires Wa. The protective member HP7 is constituted by a protector P7 and the tape TA, and the electric wires Wa are covered around with the protective member HP7.

As shown in FIGS. 30 and 31, the protector P7 constituting the protective member HP7 has the rectangular part 16, which is similar to the protector P6 of the wire harness WH6 according to the sixth embodiment. In the protector P7, the rectangular part 16 has a notch portion 16a obtained by notching the flat plate portions 12,13, and 14. Accordingly, the rectangular part 16 is divided into a pair in a routing direction of the electric wires Wa. Each of the pair of rectangular parts 16 is provided with the lock portion 17 at each of an edge portion of the flat plate portion 13 on the flat plate portion 14 side and an edge portion of the flat plate portion 14 on the flat plate portion 13 side. The edge portions of the flat plate portions 13 and 14 are locked by the lock portions 17.

In the wire harness WH7, the electric wires Wa pass through the divided rectangular parts 16 of the protector P7, and the tape TA is wound around the electric wires Wa and the flat plate portion 11 in the notch portion 16a of the protector P7.

In this manner, in the wire harness WH7 including the protective member HP7 constituted by the protector P7 and the tape TA, the entire periphery covered with the protector P7 can be the highly protected area AH protected at a higher protection strength than the normally protected area AN. In the highly protected area AH covered with the rectangular parts 16 of the protector P7, a portion covered with only the tape TA in the notch portion 16a is the normally protected area AN (see FIG. 28).

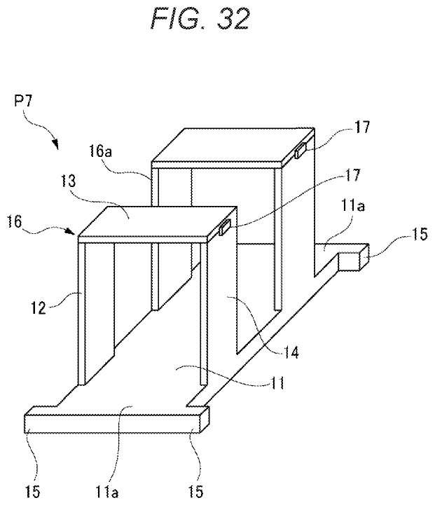

As shown in FIG. 32, in the protector P7, the flat plate portion 11 may include the extending portions 11a including the flange portions 15. In this case, the tape TA can be wound around the electric wires Wa at the extending portions 11a of the flat plate portion 11 of the protector P7, and the electric wires Wa can be more reliably bundled to the protector P7.

The present disclosure is not limited to the above-described embodiments and can be appropriately modified, improved and the like. In addition, materials, shapes, sizes, numbers, arrangement positions and the like of components in the above-described embodiments are freely selected and are not limited as long as the present disclosure can be implemented.

Here, features of the wire harnesses according to the embodiments of the present disclosure described above are briefly summarized and listed in the following [1] to [6]. [1] A wire harness (WH1 to WH7) including:
a protective member (HP1 to HP7) configured to protect an electric wire (Wa) routed in a vehicle, wherein
the protective member (HP1 to HP7) is constituted by a protector (P1 to P7) and a tape (TA),
the protective member (HP1 to HP7) has at least one of the protector (P1 to P7) and the tape (TA) covering the electric wire (Wa) around,
a portion where the electric wire (Wa) is covered with the protector (P1 to P7) is a place where interference with the electric wire (Wa) from an external interference member installed in the vehicle is large compared with a portion where the electric wire (Wa) is covered with the tape (TA), and
the tape (TA) has a protection function equivalent to that in a case where the electric wire is covered with a tube, by being wound around the electric wire to overlap at least half of the tape in a width direction thereof.

According to the wire harness having the configuration of the above [1], the tape can be wound to be in tight contact with the electric wire and the protector while ensuring the protection function equivalent to that in a case where the electric wire is covered with a tube and preventing peeling due to floating. In addition, as compared with the portion covered with the tape, the place of the electric wire where the interference with the external interference member is large is covered with the protector. Accordingly, as compared with a structure in which the electric wire is uniformly covered with and protected by the protector, the electric wire can be appropriately protected against the external interference member while reducing the cost.

[2] The wire harness according to [1], wherein
the protector (P1 to P4) has an L-shaped part (10) constituted by two flat plate portions (11, 12) in a vertical cross section relative to an extending direction of the electric wire (Wa), and
the electric wire (Wa) is covered with the tape (TA) at least at one of the flat plate portions (11) extending in the extending direction of the electric wire (Wa).

According to the wire harness having the configuration of the above [2], the electric wire can be reliably protected by the flat plate portion constituting the L-shaped part of the protector, the electric wire can be covered with and protected by the tape at least at one flat plate portion extending in the extending direction of the electric wire, and the electric wire can be bundled to the protector.

[3] The wire harness according to [2], wherein
the wire harness includes a branch electric wire (Wb) branching from the electric wire (Wa), and
the protective member (HP1) and the branch electric wire (Wb) are covered with the additional tape in a state where the branch electric wire (Wb) is routed to extend in the extending direction of the electric wire (Wa) on an outer peripheral side of the tape (TA) at a portion where the electric wire (Wa) is covered with the tape (TA).

According to the wire harness having the configuration of the above [3], the electric wire Wb for the additional circuit can be easily wound around the protective member HP1 and arranged side by side with the wire harness WH1.

[4] The wire harness according to [1], wherein
the protector (P6 and P7) has a rectangular part (16) constituted by four flat plate portions (11 to 14) in a vertical cross section relative to an extending direction of the electric wire (Wa), and
the electric wire (Wa) is covered with the tape (TA) at least at one of the flat plate portions (11) extending in the extending direction of the electric wire (Wa).

According to the wire harness having the configuration of the above [4], the electric wire can be reliably protected by the flat plate portion constituting the rectangular part of the protector. Further, at the at least one flat plate portion extending in the extending direction of the electric wire, the electric wire can be covered with and protected by the tape, and the electric wire can be bundled to the protector.

[5] The wire harness according to [4], further including:
a notch portion obtained by notching three flat plate portions among the four flat plate portions in the same position in the extending direction of the electric wire, wherein
a pair of the rectangular parts are obtained in the extending direction of the electric wire with the notch portion interposed therebetween.

According to the wire harness having the configuration of the above [5], when there are, on the wiring route, a pair of portions where the interference with the external interference member is large with a portion where the interference with the external interference member is small interposed therebetween, the electric wire can be appropriately protected against the external interference member while reducing the cost.

[6] The wire harness according to any one of the above [2] to [5], wherein
each of the flat plate portions (11) extending in the extending direction of the electric wire (Wa) includes a flange portion (15) at each of end portions thereof.

According to the wire harness having the configuration of the above [6], the flange portion is formed on each of the end portions of the flat plate portions. Accordingly, due to the flange portion, the tape is prevented from being pulled out when being wound around the electric wire. Accordingly, the tape can be reliably wound.

[7] A manufacturing method of a wire harness (WH1 to WH7) having a protective member (HP1 to HP7) configured to protect an electric wire (Wa) routed in a vehicle is provided. The protective member (HP1 to HP7) includes a protector (P1 to P7) and a tape (TA). The manufacturing method includes covering a portion of the electric wire (Wa) being a place where interference with the electric wire from an external interference member installed in the vehicle with the protector (P1 to P7), and winding, with the tape (TA), the electric wire (Wa) covered with the protector (P1 to P7) to overlap at least half of the tape (TA) in a width direction thereof. The tape (TA) has a protection function equivalent to that in a case where the electric wire is covered with a tube.

What is claimed is:

1. A wire harness comprising:
a protective member configured to protect an electric wire routed in a vehicle, wherein
the protective member is constituted by a protector and a tape,
a surrounding of the electric wire is covered with at least one of the protector and the tape of the protective member,
a portion where the electric wire is covered with the protector is a place where interference with the electric wire from an external interference member installed in the vehicle is large compared with a portion where the electric wire is covered with the tape, and
the tape has a protection function equivalent to that in a case where the electric wire is covered with a tube, by being wound around the electric wire to overlap at least half of the tape in a width direction thereof.

2. The wire harness according to claim 1, wherein
the protector has an L-shaped part constituted by two flat plate portions in a vertical cross section relative to an extending direction of the electric wire, and
the electric wire is covered with the tape at least at one of the flat plate portions extending in the extending direction of the electric wire.

3. The wire harness according to claim 2, wherein
the wire harness includes a branch electric wire branching from the electric wire, and
the protective member and the branch electric wire are covered with the additional tape in a state where the branch electric wire is routed to extend in the extending direction of the electric wire on an outer peripheral side of the tape at a portion where the electric wire is covered with the tape.

4. The wire harness according to claim 1, wherein
the protector has a rectangular part including four flat plate portions in a vertical cross section relative to an extending direction of the electric wire, and
the electric wire is covered with the tape at least at one of the flat plate portions extending in the extending direction of the electric wire.

5. The wire harness according to claim 4, further comprising:
a notch portion formed by notching three flat plate portions among the four flat plate portions in the same position in the extending direction of the electric wire, wherein
a pair of the rectangular parts are formed in the extending direction of the electric wire with the notch portion interposed therebetween.

6. The wire harness according to claim 2, wherein
each of the flat plate portions extending in the extending direction of the electric wire includes a flange portion at each of end portions thereof.

7. A manufacturing method of a wire harness having a protective member configured to protect an electric wire routed in a vehicle,
the protective member includes a protector and a tape,
the manufacturing method comprising:
covering a portion of the electric wire being a place where interference with the electric wire from an external interference member installed in the vehicle with the protector; and
winding, with the tape, the electric wire covered with the protector to overlap at least half of the tape in a width direction thereof.
